(19) United States
(12) Patent Application Publication
(10) Pub. No.: US 2016/0210440 A1
(43) Pub. Date: Jul. 21, 2016

(54) System and Method for Treatment of Insomnia and Other Disorders

(71) Applicant: Sleep Data Services, LLC, San Diego, CA (US)

(72) Inventors: Dominic Munafo, San Diego, CA (US); Bretton Hevener, San Diego, CA (US); Thinh Nguyen, San Diego, CA (US); Derek Loewy, San Diego, CA (US); Andrew Molesworth, San Diego, CA (US); Megan Byrne, San Diego, CA (US); Michael Floyd, San Diego, CA (US)

(21) Appl. No.: 15/002,317

(22) Filed: Jan. 20, 2016

Related U.S. Application Data
(60) Provisional application No. 62/105,653, filed on Jan. 20, 2015.

(51) Int. Cl. G06F 19/00

(52) U.S. Cl. CPC G06F 19/3481; G06F 19/3431; G06F 19/345

(57) ABSTRACT

A human disorder treatment system and method is presented. A disorder diagnosis computing system receives patient data from one or more data input sources, and processes the patient data to generate a diagnosis or risk assessment about a disorder related to a patient associated with the patient data. An output system generates a set of factors and a set of therapy modules based on the diagnosis or risk assessment, the set of therapy modules using the set of factors to generate one or more therapies for the patient to treat the disorder. A client computing system executes the set of therapy modules to incentivize the patient to undergo the one or more therapies to treat the disorder, to monitor a progress of the patient undergoing the one or more therapies, and to generate a reward for the patient for exceeding a desired outcome of undergoing the one or more therapies.

### CROSS-REFERENCE TO RELATED APPLICATION

This application claims the benefit of U.S. patent application Ser. No. 62/105,653, filed on Jan. 20, 2015, and entitled “SYSTEM AND METHOD FOR TREATMENT OF INSOMNIA AND OTHER DISORDERS,” which is incorporated by reference herein in its entirety.

### TECHNICAL FIELD

The subject matter described herein relates to a system and method for treatment of disorders through cognitive behavior therapy, gamification, and other behavioral change methods. The system and method can be applied to one or more of any number or type of disorders, such as insomnia, for example.

### BACKGROUND

One of the most challenging aspects of healthcare is achieving satisfactory compliance for a therapy to address a disorder. Many patients do not follow the therapeutic regimen prescribed by their doctors. For example, approximately 50% of patients with a chronic illness do not take the medications as prescribed by their physician.

Previous attempts to incentivize patients to achieve compliance with their therapy have been unsuccessful. Further, any such system must conform to the regulations outlined in the Federal Register Vol. 76, No. 106 Part II Department of Health and Human Services 45 CFR Parts 146 and 147, or as amended from time to time. These regulations specify the maximum permissible reward or incentive provided by a health contingent wellness program offered in connection with a group health plan or any related health insurance coverage. They also state conditions under which these programs can operate.

What is needed is a system and method that incentives compliance with a therapy for a disorder, while meeting any regulatory or legal requirements.

### SUMMARY

To address the issues described above, a system and method in accordance with implementations described herein use multiple engagement mechanisms to drive participation in a therapy that addresses a disorder.

In some aspects, a human disorder treatment system and method are presented. A disorder diagnosis computing system receives patient data from one or more data input sources, and processes the patient data to generate a diagnosis or risk assessment about a disorder related to a patient associated with the patient data. An output system generates a set of factors and a set of therapy modules based on the diagnosis or risk assessment, the set of therapy modules using the set of factors to generate one or more therapies for the patient to treat the disorder. A client computing system executes the set of therapy modules to incentivize the patient to undergo the one or more therapies to treat the disorder, to monitor a progress of the patient undergoing the one or more therapies, and to generate a reward for the patient for exceeding a desired outcome of undergoing the one or more therapies.

Cognitive behavior therapy (CBT) has been shown to be an effective treatment method for disorders such as insomnia. However, there is ample opportunity to improve the efficacy of a CBT program by incorporating its principles into a more comprehensive platform that reinforces the behaviors prescribed by cognitive behavior therapy. These reinforcing mechanisms can be: 1) Better targeting of the clinical therapy regimen based on a patient's specific circumstances for higher efficacy; 2) Providing monetary or material incentive mechanisms to drive the patient to perform the tasks in the clinical regimen; 3) Creating engagement through appropriate, research-validated psychological methods to internalize the positive behavior patterns created by the therapy.

By reinforcing the efficacy of a cognitive behavior therapy program through these mechanisms, the probability of successful treatment is increased. In a preferred exemplary implementation, these mechanisms can be incorporated in a system and method to treat insomnia. The description herein describes how the system works for insomnia as an exemplar for how any disorder might be incorporated into the system. Examples of other disorders that can be treated or mitigated by the system include, but are not limited to, depression, diabetes, obesity, substance abuse, mental disorders and chronic health conditions such as asthma, hypertension and congestive heart failure.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a number of functional modules for an input to a system;

FIG. 2 illustrates an example challenge card.

FIGS. 3A-C show an example of input screens in accordance with some implementations.

FIG. 4 shows an example recommendation screen in accordance with implementations described herein.

FIG. 5 illustrates an example of a user dashboard with an activity feed, for being generated by a computer processor for rendering in a graphical display, in accordance with some implementations

When practical, similar reference numbers denote similar structures, features, or elements.

### DETAILED DESCRIPTION

This document describes a system and method to drive participation in a therapy that addresses a disorder, and presenting an ability to use multiple engagement mechanisms to drive such participation.

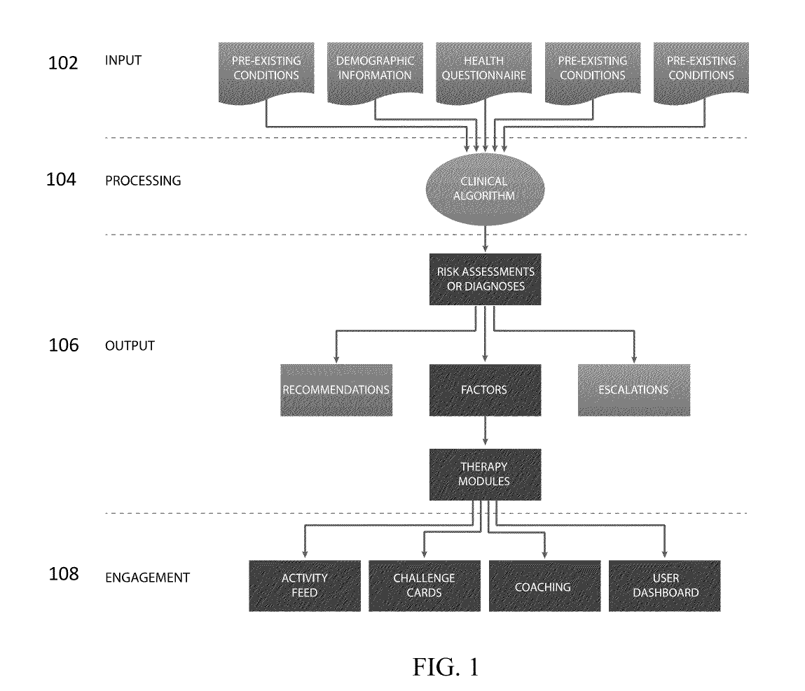

FIG. 1 illustrates a system for incentivizing a patient's participation in a therapy or regiment for treatment of a disorder. The system can be divided into four main component areas or “layers,” each of which can be implemented as a separate processing module or computing system: input 102, processing 104, output 106, and engagement 108. Within each component area are sub-modules that perform specific functions.

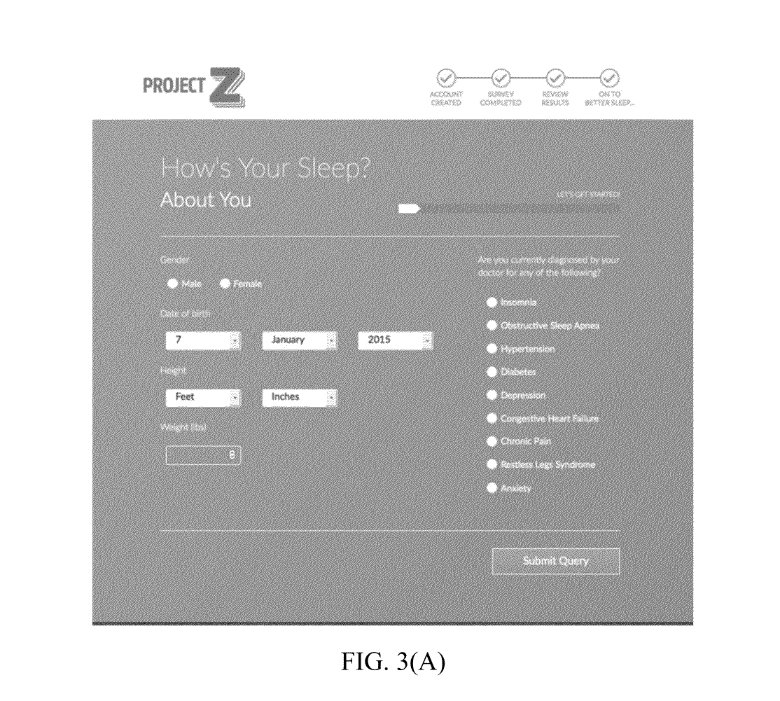

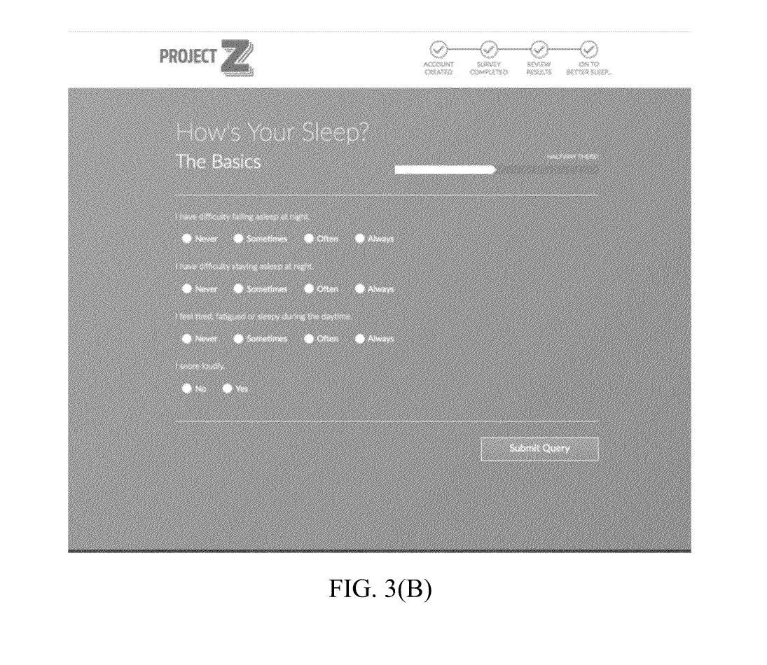

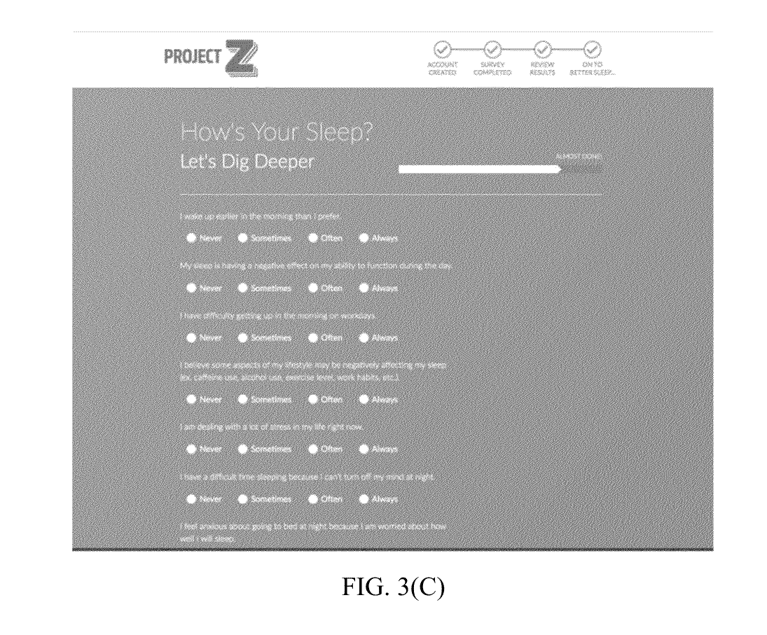

The input layer 102 includes functional modules that capture information from the user. In some implementations, as shown in FIG. 1, a number of functional modules are shown for the input 102: demographic information such as gender, age, height and weight are captured by one or more of these sub-modules for baselining purposes, statistical analysis, and input into the clinical algorithms; a health centric questionnaire obtains data points concerning the current health condition of the patient. This health questionnaire is clinically based, and can also be a clinically validated screening mechanism for a disorder, if necessary. It can also incorporate questions for multiple disorders, recording traits such as frequency and severity. Other functional modules or sub-modules can include pre-existing health conditions, which are also captured by a computer processor through questions presented to a user via a computer session during the input phase. The system uses this information to tailor a resulting therapy regimen, such that it will not interfere with any of the user's existing therapy regimens. Devices such as wearables, i.e. wrist band, sensor band or belt, etc., can also provide data input to the system. This data stream is used in the clinical algorithms. Additional health information, such as the user's genetic information can also be inputted into clinical algorithms. A computer can generate one or more input screens, by which a user can enter the input information. An example of input screens in accordance with some implementations, depicting demographic information, questions, and pre-existing conditions, is shown in FIGS. 3A-C.

Once the input is obtained, the system executes and applies processing algorithms to the responses to personalize the experience and therapy regimen for each specific user. The processing uses the following logic. Based on a user's responses to the questions asked in the input section, a severity rating or risk assessment is applied to the disorders that are addressable by the system. In an example case, the system rates the severity of a user's insomnia on a scale from 0 to 3, with 0 being no severity and 3 being high severity. The example case also incorporates a low or high rating for the user's sleep apnea risk. These ratings for a disorder are termed a condition state, i.e. high-insomnia or low-OSA.

For disorders where there are contributing factors that drive the severity rating, the system prioritizes and scores the magnitude of these contributing factors through a set of clinical algorithms. The prioritization and scoring of these contributing factors will vary directly based on how a user answers the questions presented in the input section, resulting in a therapy regimen personalized specifically to the user. For example, a user's high severity insomnia may be driven by contributing factors such as poor health lifestyle, sleep hygiene, stress and conditioned arousal. These contributing factors are prioritized and weighted per the user's responses and other data points provided during the input phase. The clinical algorithms therefore prescribe a therapy regimen that would specifically address these contributing factors.

These algorithms are based on the experience and best practices of the medical experts and best practices within the industry. In accordance with the example above, a list of contributing factors for insomnia are listed below:

Sleep Deprivation

Conditioned Arousal

Chronic Stress

Jet Lag Syndrome

Shift Work Syndrome

Sleep Hygiene—Lifestyle Factors

Sleep Hygiene—Environmental Factors

Hypnotics

Delayed Sleep Phase Syndrome

Advanced Sleep Phase Syndrome

Obstructive Sleep Apnea

In a case where the system processes the user's input and determines that the user screens negative for the disorders treated by the system, the user is assigned a set of “non-clinical” factors. These factors are associated to therapy regimens that reinforce but do not interfere with the good health and positive behaviors of the user. The addition of non-clinical factors allows the system to create a regimen for all users, even for users who have been assessed as healthy. In essence, the therapy regimens associated to non-clinical factors “do no harm” if a user has healthy practices with respect to a disorder. The assignment of tasks to healthy users adheres to U.S. Federal regulations requiring non-discrimination and equal opportunity to earn incentives for wellness programs, as discussed in the section title “Considerations for Federal Regulation: Dept. Health and Human Services 45 CRF Parts 146 and 147”, for example.

The system and method further includes an output 106. Diagnoses, risk assessments, recommendations, escalations, factors and therapy modules specific to the user are outputted after the system executes and applies clinical and operational algorithms to process input data. Each of the output types is described as follows.

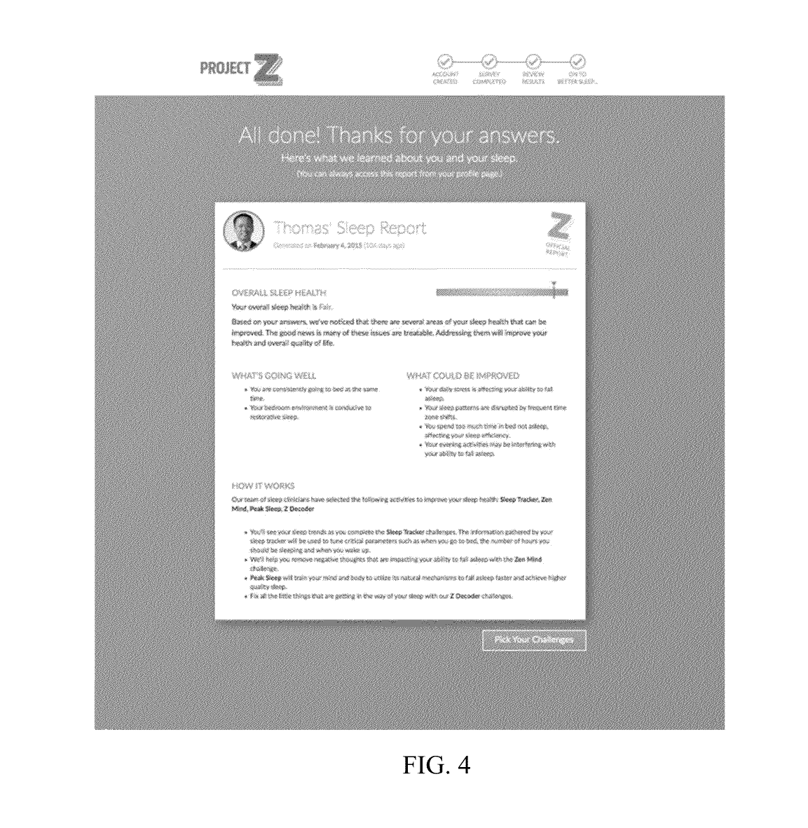

Diagnoses can be determined through the clinical algorithms based on the input data. Similarly, a risk assessment for heath conditions can be determined based on the input data. Recommendations are the conclusions and follow on actions that the system derives for the user, based on the user's factors. These are presented directly to the user in a simple to understand manner. An example Recommendation screen is presented in FIG. 4.

Escalations are instructions for the user to follow up with an external party, such as their physician or a health coach, for conditions that the system is unable to treat by itself. For example, the clinical algorithms might identify that a pre-existing condition precludes using the therapy modules with the system and that a physician should intervene before the user proceeds further.

Factors that drive the user's condition are, as previously described, calculated, prioritized and weighted. Based on these determined factors, a user will receive a set of recommendations and a regimen consisting of therapy modules weighted specifically for the user. These factors may or may not be explicitly reported to the user. In the example system, they are not displayed to the user. If the combination of factors results in duplicative therapy modules being assigned to the user, the system reduces the duplication of the therapy module and re-prioritizes the weighting of the therapy modules.

Therapy modules are the clinical treatments selected to address the condition. They contain the actions that the user should take in order to improve their health. In the case of non-clinical factors for a healthy patient, the selected therapy modules consist of actions that do not interfere with the patient's positive health habits.

Some current therapy modules, along with how they are currently presented in the system, are listed below:

Sleep Diary

Hygiene Tips—Lifestyle

Hygiene Tips—Environmental

Hygiene Education

Stimulus Control

Sleep Compression

Worry Exercise

Delayed Sleep Phase Protocol

Advanced Sleep Phase Protocol

Hypnotics Taper Protocol

Jet Lag Protocol

Shift Work Protocol

Sleep Deprivation Education

Sub Clinical Education

Relaxation Therapy

AM Light Therapy

Exercise Therapy

OSA Diagnostic Test

OSA Education

To address the issue of non-compliance or non-engagement, the system uses multiple engagement mechanisms to drive participation in the therapy. In accordance with some implementations, the most significant of these mechanisms is gamification. In preferred exemplary implementations, the engagement mechanism includes an interactive computing device, and preferably a mobile computing device, for executing the gamification of compliance of any developed therapy.

Gamification takes the principles and psychology of games and applies them in non-game contexts to engage and motivate people to achieve goals. The system uses design concepts from gaming, such as incentivization, milestones, status, competition, personalization and social support to increase engagement and thereby therapy compliance in order to achieve a more successful health outcome.

In one implementation of a gamified program, a user is extrinsically motivated to perform tasks through a reward system that grants points for performing tasks, such as taking the screening questionnaires or performing therapy tasks. Points can be accumulated until a threshold value is reached. These points can be redeemed towards prizes, lottery tickets, or other material rewards such as a reduction in a healthcare premium.

In one implementation of the gamified program, the user's therapy modules and their associated tasks are presented as challenge cards that the user accepts and completes for points. These challenge cards can have properties that regulate how a clinical treatment is to be performed such as expirations, prerequisites, verification and repeatability.

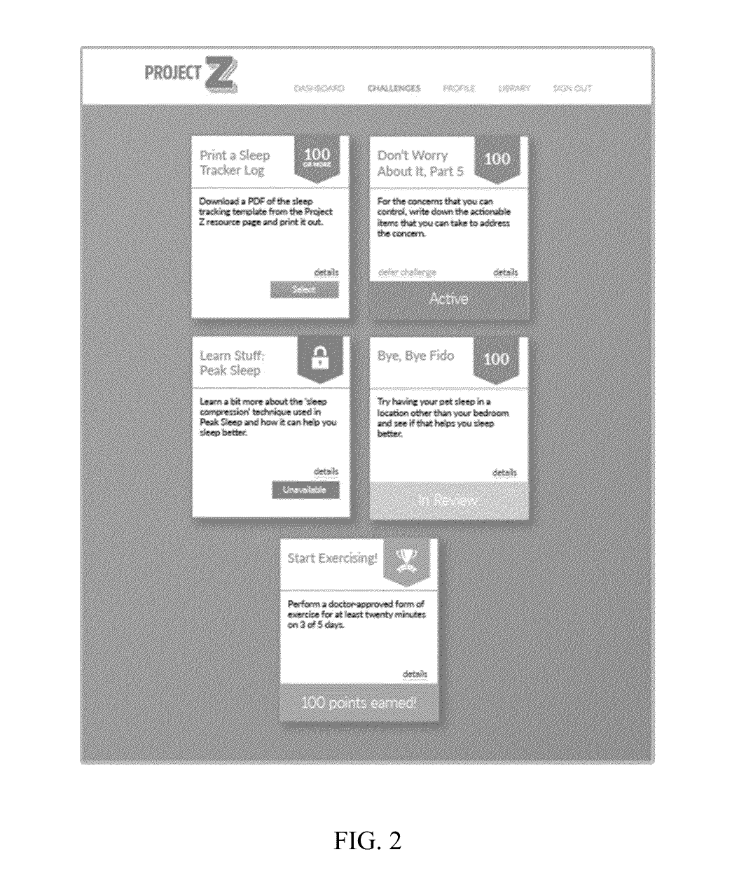

FIG. 2 illustrates an exemplary challenge card, which can be implemented in hardcopy or electronically as softcopy. A challenge card can have the following properties:

Expiration: When accepting a challenge card, a user may be required to perform the task within a certain time frame. If the user does not meet this time constraint, the challenge expires, and the user is not awarded any points for any activities performed.

Prerequisite: Before the activity on a challenge card can be undertaken, another action or set of actions must be completed. These prior actions are prerequisites that keep a challenge card locked from the user until they are completed. The prerequisites can be another challenge card, the completion of an entire therapy module, or any other condition that can be inputted or tracked by the system.

Verification: After performing the action listed on a challenge card, a user may automatically be given the points for that card when the user states that she has performed the action. This is an example of self-verification. However, there may be some actions that require an external party to verify completion. In this case, the user submits the challenge card for verification and a third party, such as a health coach or benefits manager, takes an action to verify that the user has successfully met the criteria for being awarded the point value of the challenge card. The third party verifier can be given a time limit within which to verify the action.

Repeatability: Some activities should be performed over and over, since repeating a positive action helps to turn it into a habit. To accommodate this behavior, challenges cards can be repeatable. They can also have a maximum time that they can be repeated, and a limit to the number of times that points can be awarded for performing the action if they are repeated. If the repeat limit is higher than the award limit, then any time the user performs the action on the challenge card beyond the award limit, points towards earning the incentive are not awarded. However, other positive reinforcement, such as badges and virtual goods, can be awarded in lieu of earning points towards a material reward.

A key premise of the system is to reward positive behavior through extrinsic and material incentives initially, but then convert the user to be intrinsically motivated to perform the actions on the challenge cards because they result in a better quality of life or health, or convert the user to be extrinsically motivated to earn virtual goods or status that does not have a financial cost. As the system creates challenge cards, and a user interacts with a challenge card, the system keeps track of the user's progress for the card. This progress is denoted by the following states:

Allocated: Allocated cards are the entire set of challenge cards that are assigned by a user as part of his personalized set of therapy modules, without regard to prerequisites or other considerations.

Available: These are challenge cards that the user can select because they have no prerequisite or because their prerequisite has been met.

Accepted: Accepted cards are the challenge cards that a user has selected to perform.

Submitted: Submitted cards are those that a user sends to the system for verification after completing the task, either automatically by an algorithm or manually by a person.

Verified: A verified card is one that has passed a verification condition.

Awarded: An awarded card is one that has been completed and verified successfully, resulting in the user earning any points associated with the card.

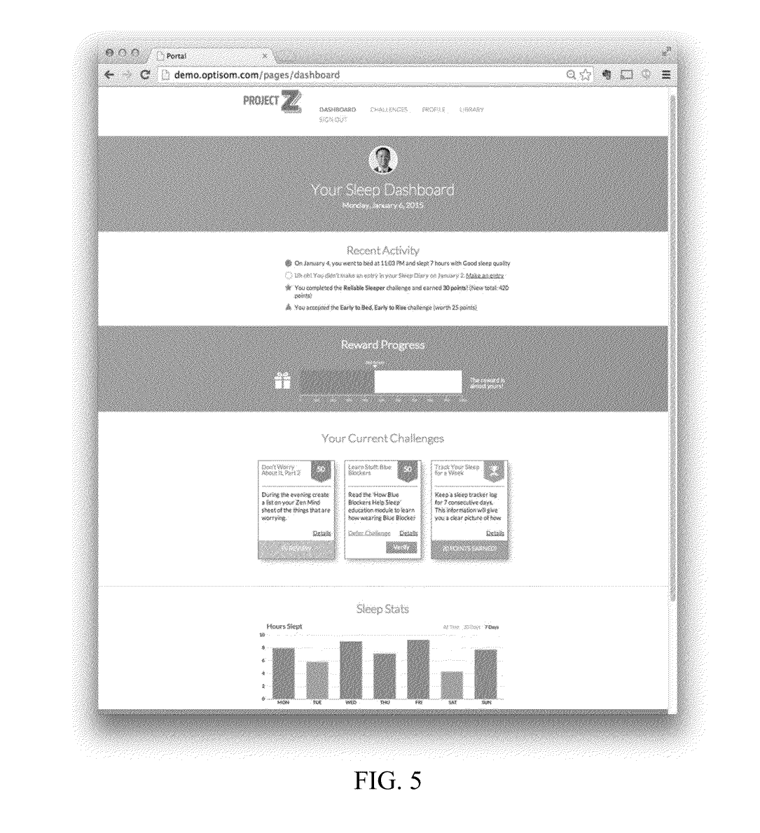

To drive user engagement, the user is presented with a dashboard that contains real time information about his progress towards earning points or incentives, challenge card status, and other activity information such as individual trends, departmental or corporate status updates. Dynamic information and updates are highlighted in an activity feed with which the user can interact. FIG. 5 illustrates an example of a user dashboard with an activity feed, for being generated by a computer processor for rendering in a graphical display, in accordance with some implementations.

User accessibility and convenience are also key drivers of engagement. To maximize accessibility, a user can interact with the system through multiple interfaces, and the system can communicate back to the user through multiple channels. For example, the user can access the system functionality through a standard web browser running on a personal computer, a web browser running on a smartphone or tablet computing device, or a mobile application on a smartphone or tablet computing device. The visual design and user interaction design accommodates all of these different modes of interaction. In addition to communicating with the user via the aforementioned methods, the system can send messages, reminders, updates and notifications to the user via email, text, or in-app messaging. In some implementations, the system can incorporate instant messaging functionality to facilitate communication from a health coach to the end user.

In addition to creating a personalized set of therapy modules and challenge cards based on the user's specific circumstances, the system modifies ongoing therapy tasks based on real time data collected from the user, their wearable device or other user specific data source. For example, the system might adjust the recommended bedtime and wake time on a challenge card based on a clinical algorithm that takes into account the user's sleep habits for the previous set of nights. This ongoing personalization helps the user stay engaged as the system continuously responds to the user's actions.

The system incorporates social support mechanisms where a user can choose to post their activities and updates to a social network to garner support through ‘likes’, comments and other methods from their network. This public broadcast creates a sense of accountability and community support for the activity, thereby increasing the user's engagement.

In some implementations, the system provides mechanisms such as keeping track of points between individuals and/or groups, displaying rankings and broadcasting achievements to engage the user through competition. The system can also provide health coaches to directly interact with users on an as needed basis, on any of a suitable communication medium. The ability to connect the user with directly with another person can guide and reinforce the user's engagement with the overall system.

As described above, the system, and methods executed thereby, are designed to conform to the regulations outlined in the Federal Register Vol 76, No. 106 Part II Department of Health and Human Services 45 CFR Parts 146 and 147, or as amended from time to time, and conform to the following criteria:

Frequency of Opportunity to Qualify: The regulations state that a user must be given the opportunity to qualify for the reward at least once per year. The system meets this requirement by allocating points to challenge cards in such a manner that the user can complete enough cards to the reach the threshold for the reward within a one year time frame.

Size of Reward: The regulations specify that the maximum permissible reward cannot exceed 30 percent of the cost of the coverage unless the wellness program is designed to prevent or reduce tobacco use, in which case the maximum permissible reward increases to 50 percent of the cost of the coverage. Since this is a business decision, the system does not directly address the financial size of the reward offered once the user meets the point threshold required to earn the incentive.

Reasonable Design: The regulations stipulate that the health contingent wellness program be reasonably designed to promote health or prevent disease. By incorporating clinically validated or derived screening and therapy methods such as cognitive behavior therapy, the system meets this requirement to promote health; in the exemplar case presented, the system is designed to directly and positively impact sleep health through the treatment of insomnia.

Uniform Availability and Reasonable Alternative Standards: The regulations state that the full reward under a health contingent program be made available to all similarly situated individuals whereby similarly situated individuals designations are based on job classification. The system meets this requirement by personalizing the therapy modules based on a user's screening responses, and distributing the exact same number of points across the different tasks assigned to any given user. So, regardless of the user's health condition, he has the same opportunity to earn the points required for obtaining the reward. This makes the system “uniformly available”. The reasonable alternative standard clause is activated when a user is unable to perform the challenge cards in the standard therapy modules based on a medical issue. In this case, the program must offer another mechanism for the user to earn the reward. For these exceptions, the wellness program administrator would provide a customized set of challenge cards that provide an alternative set of tasks for the user to perform to earn points towards the rewards.

Notice of Availability of Reasonable Alternative Standard: The regulation requires that the health plan and issuer disclose the availability of a reasonable alternative standard to qualify for the reward in all plan materials describing the terms of a health contingent wellness program. Since this is a requirement for the marketing of a wellness program, the system does not need to address this particular regulation.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A human disorder treatment system comprising:
a disorder diagnosis computing system that receives patient data from one or more data input sources, the disorder diagnosis computing system processing the patient data to generate a diagnosis or risk assessment about a disorder related to a patient associated with the patient data;
an output system that generates a set of factors and a set of therapy modules based on the diagnosis or risk assessment, the set of therapy modules using the set of factors to generate one or more therapies for the patient to treat the disorder; and
a client computing system that executes the set of therapy modules to incentivize the patient to undergo the one or more therapies to treat the disorder, to monitor a progress of the patient undergoing the one or more therapies, and to generate a reward for the patient for exceeding a desired outcome of undergoing the one or more therapies.

2. The system in accordance with claim 1, wherein the client computing system generates one or more graphics for display by the client computing system, the one or more graphics representing the one or more therapies generated by the set of therapy modules.

3. The system in accordance with claim 1, wherein the disorder is related to a sleep disorder.

4. The system in accordance with claim 1, wherein the client computing system monitors the progress of the patient via input from one or more sensors or wearable devices applied to the patient and in communication with the client computing system.

5. The system in accordance with claim 1, wherein the client computing system generates a digital representation of the reward, the digital representation being transmittable over a network to a reward redemption system.

6. A human disorder treatment method comprising:
receiving, by a disorder diagnosis computing system, patient data from one or more data input sources;
processing, by the disorder diagnosis computing system, the patient data to generate a diagnosis or risk assessment about a disorder related to a patient associated with the patient data;
generating, by an output system, a set of factors and a set of therapy modules based on the diagnosis or risk assessment, the set of therapy modules using the set of factors to generate one or more therapies for the patient to treat the disorder; and
executing, by one or more data processors, the set of therapy modules to incentivize the patient to undergo the one or more therapies to treat the disorder, to monitor a progress of the patient undergoing the one or more therapies, and to generate a reward for the patient for exceeding a desired outcome of undergoing the one or more therapies.

7. The method in accordance with claim 6, further comprising generating one or more graphics for display by a client computing system, the one or more graphics representing the one or more therapies generated by the set of therapy modules.

8. The method in accordance with claim 6, wherein the disorder is related to a sleep disorder.

9. The method in accordance with claim 7, further comprising monitoring, by the client computing system, the progress of the patient via input from one or more sensors or wearable devices applied to the patient and in communication with the client computing system.

10. The method in accordance with claim 6, further comprising generating a digital representation of the reward, the digital representation being transmittable over a network to a reward redemption system.
